(19) United States
(12) Patent Application Publication
(10) Pub. No.: US 2005/0000890 A1
(43) Pub. Date: Jan. 6, 2005

(54) Hydroentangled liquid filter media and method of manufacture

(75) Inventors: Charles Eric Pearce, Huntersville, NC (US); Sergio Diaz deLeon, Huntersville, NC (US); Michael Putnam, Fuquay-Varina, NC (US); Cheryl Carlson, Willow Springs, NC (US); Ping Hao, Charlotte, NC (US); Richard Faulkner, Salisbury, NC (US)

Correspondence Address: WOOD, PHILLIPS, KATZ, CLARK & MORTIMER, 500 W. MADISON STREET, SUITE 3800, CHICAGO, IL, 60661, US

(73) Assignee: Polymer Group, Inc.

(21) Appl. No.: 10/778,661

(22) Filed: Feb. 13, 2004

Related U.S. Application Data
(60) Provisional application No. 60/447,464, filed on Feb. 14, 2003.

(51) Int. Cl. B01D 39/14

(52) U.S. Cl. 210/496; 210/503

(57) ABSTRACT

A filter media comprising hydroentangled predominant polyester staple length fibers having a basis weight of no more than about 12 oz/yd², an air permeability of at least about 180 cfm, and machine-direction and cross-direction shrinkage of less than about 3%, exhibiting greater than about 85% capture efficiency with particle sizes in the range of about 30 to 40 microns, and exhibiting greater than about 60% capture efficiency with particle sizes I the range of 20 to 30 microns.

### TECHNICAL FIELD

The present invention relates generally to a nonwoven fabric employed as a filter media, and more particularly to a liquid filter media comprising a hydroentangled nonwoven fabric, and a method of making the liquid filter media through the use of a foraminous surface, said formed nonwoven liquid filter media exhibiting greater than about 85% capture efficiency with particles sizes in the range of 30 to 40 microns and exhibiting greater than about 60% capture efficiency with particle sizes in the range of 20 to 30 microns. Filter materials formed in accordance with the disclosed concept are particularly useful in applications where the filtrate is sensitive to contamination as the mechanism of formation of the filter material allows for the advantageous removal of contaminates such as fiber finishes, fiber preservatives, and other intentional or inadvertently adsorbed/absorbed chemical agents.

### BACKGROUND OF THE INVENTION

Filtration of fluids, such as gases, requires the removal of particulate or disparate impurities from the gas stream in order to limit introduction of those impurities into the environment, or circulation back into the associated process. It is ordinarily desirable to maximize the surface area available for filtration so as to remove large amounts of undesirable contaminants from the fluidic stream, while maintaining the operating pressure differential induced by the filter to as low as possible to achieve long service life and minimize system strain.

One form of filtration is typically referred to as being of the interception type, that is, the filter media functions in the nature of a sieve that mechanically entraps particles larger than the pore size inherent to the filter media. Larger particles are removed from the fluidic stream by the openings in the filter media, with particles building on top of one another to create a filter cake that removes successively smaller particles.

More specifically, in a so-called “liquid filter”, particulate material is removed from a liquid stream, as exemplified by industrial and consumable manufacturing processes, by directing the stream through the filter media. Particulates may be removed from the liquid stream by individual or combination of performance mechanisms, such as by depth and impedance. Various shapes or forms of liquid particulate filters can be fabricated so as to be system adaptable.

Heretofore, nonwoven fabrics have been advantageously employed for manufacture of filter media. Generally, nonwoven fabrics employed for this type of application have been entangled and integrated by mechanical needle punching, sometimes referred to as “needle-felting”, which entails repeated insertion and withdrawal of barbed needles through a fibrous web structure. While this type of processing acts to integrate the fibrous structure and lend integrity thereto, the barbed needles inevitably shear large numbers of the constituent fibers, and undesirably create perforations in the fibrous structure, which act to comprise the integrity of the filter and can inhibit efficient filtration. Needle punching can also be detrimental to the strength of the resultant fabric, requiring that a suitable nonwoven fabric have a relatively higher basis weight in order to exhibit sufficient strength for filtration applications.

The present invention is directed to a liquid filter media, and method of making, which is formed through hydroentanglement, thus avoiding the deleterious effects of mechanical needling, while providing a filter media having the requisite strength characteristics, and highly desirable uniformity for cost-effective use.

### SUMMARY OF THE INVENTION

A filter media formed in accordance with the present invention comprises hydroentangled, predominantly polyester staple length fibers having a basis weight of no more than about 12 oz/yd². The filter media exhibits an air permeability of at least about 100 cubic feet per minute (cfm), and machine-direction and cross-direction shrinkage of less than about 3%, preferably less than about 2%. The filter media exhibits a machine-direction tensile strength of at least about 50 lb/in, and a cross-direction tensile strength of at least about 50 lb/in. Further, the nonwoven filter media of the present invention exhibits greater than about 96% capture efficiency with particles sizes in the range of 30 to 40 microns and exhibiting greater than about 80% capture efficiency with particle sizes in the range of 20 to 30 microns.

The present filter media is made formed by providing a precursor web comprising predominantly staple length thermoplastic fibers. The present method further comprises providing a foraminous surface, which may be configured to impart a repeating pattern to the filter media being formed for enhancing its filtration capabilities. The precursor web is positioned on the foraminous surface, and hydroentangled to form the present filter media in the form of a nonwoven fabric.

It is within the purview of the present invention that the filter media be heat-set subsequent to hydroentangling. By the inclusion of fusible thermoplastic fibers in the precursor web, heat setting of the filter media can desirably result in thermal bonding of the media, thus enhancing the strength characteristics of the material.

Other features and advantages of the present invention will become readily apparent from the following detailed description, the accompanying drawings, and the appended claims.

### BRIEF DESCRIPTION OF THE DRAWING

FIG. 1 is a diagrammatic view of a liquid filter arrangement for which the liquid filter media of the present invention is particularly suited for use.

### DETAILED DESCRIPTION

While the present invention is susceptible of embodiment in various forms, there is shown in the drawings, and will hereinafter be described, a presently preferred embodiment, with the understanding that the present disclosure is to be considered as an exemplification of the invention, and is not intended to limit the invention to the specific embodiments illustrated.

The present invention described herein includes the uses of hydroentangled nonwovens as described below, as a direct replacement for needled felts in all such applications where such materials are currently used. These applications include liquid handling, and liquid filtration systems as represented by pool/spa/pond water filters and milk production, and other specialty applications where needled felts are employed. The use of hydroentangling technology in the fabrication of liquid filtration materials is also of particular benefit as the manufacture process allows for the removal, or washing, of the fibrous component, thus allowing for the reduction of intentional and/or inadvertently absorbed/adsorbed chemical agents.

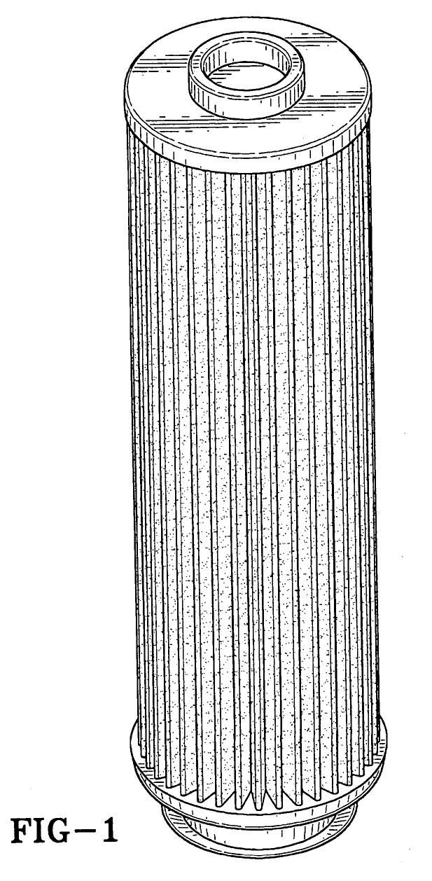

With reference to FIG. 1, therein is diagrammatically illustrated a representative liquid filter structure for use with the filter media of the present invention is suited. This type of liquid filter structure is typically employed in industrial applications requiring filtration of particulate material from a liquid stream. As illustrated, the liquid stream enters a filter chamber, within which, one or more generally tubular filter elements are arranged. In this particular example, water flows from though the exterior surface of the filter element with the corresponding creation of a pressure differential across the filter media. Particulate contaminates are removed from the liquid stream as the contaminate lodges into and against the filter media.

The liquid filter media embodying the principles of the present invention may be configured as a filter element illustrated in FIG. 1. Such a configuration is represented by U.S. Pat. No. D440,294, to Bilek, hereby incorporated by reference. For such applications, the filter media may be formed as a planar sheet, with opposite edges joined to form an open-ended tube. The tube can then be closed at one end to form a sleeve-like bag. For other applications, the filter media may be employed in its planar form, in the form of an open-ended tube, in the form of a substantially planar element, and the combinations thereof. For enhanced filtration performance, the filter material of the present invention can be optionally subjected to mechanical modification, such as by crenulation, pleating, or compaction.

Filter media embodying the principles of the present invention can be formed by hydroentanglement on a foraminous surface, such as is generally taught in Evans et al. U.S. Pat. No. 3,485,706, and as disclosed in U.S. Pat. No. 5,244,711, to Drelich et al., both hereby incorporated by reference. Depending upon the specific configuration of the foraminous surface, the fibrous material may have a repeating pattern imparted in the plane of the fabric or the repeating pattern may protrude from the plane of the fabric. A foraminous surface for practicing the present invention typically includes a meshed surface such as a screen, whereby the high-pressure liquid (water) streams directed at the fibrous material for hydroentanglement can pass through the foraminous surface.

Formation of a filter media in accordance with the present invention is effected by providing a precursor web of predominantly staple length polyester fibers selected to have a basis weight corresponding to the basis weight of the filter media being formed. In accordance with the present invention, the present filter media preferably has a basis weight of no more than about 12 oz/yd², thus facilitating efficient fabrication by hydroentanglement, and cost-effective use of the fibrous material from which the media is formed.

Depending upon the composition of the precursor web from which the present filter media is formed, the strength and integrity of the material can be desirably enhanced. By incorporation of fusible fibers, such as sheath fibers or bi-component thermoplastics including polyesters, polyamides, and/or polyolefins, it is possible to effect heat bonding of the fiber structure during heat setting of the material, subsequent to hydroentanglement. Further, it has been found that in the absence of specific fusible fibers, heat setting of the material can desirably enhance the strength and the porosity of the nonwoven fabric to improve its filtration characteristics.

By configuring the foraminous surface employed during hydroentanglement to impart a specifically-configured pattern to the filter media, filtration characteristics of the media can be further enhanced, including an increase in the effective surface area, improvement in filter cleaning efficiency, and to alteration of depth filtration performance. As will be appreciated, this is a distinct advantage in comparison to conventional needle-punched fabrics, which ordinarily cannot be meaningfully imaged in connection with mechanical entanglement.

Use of thermoplastic fibers, including, but not limited to thermoplastic aramids, such as alpha and para-aramids, and melamines, either homogenous or heterogenous and blended and/or layered in nature are contemplated within the scope of the present invention. A presently preferred fibrous component including 100% polyester staple length fibers is contemplated, as well as use of 90% polyester fibers in combination with 10% fusible sheath fibers. The fabric weight is selected to be no more than about 12 oz/yd², preferably on the order of less than about 10 oz/yd².

Notably, formation of the filter media of the present invention by hydroentanglement has been found to desirably provide the filter media with the requisite strength characteristics, and resistance to shrinkage. Filter media formed in accordance with the present invention is suitable for application in such industries as food production, paint manufacture, and water treatment. The disclosed filter media of the present invention preferably exhibits an air permeability of at least about 100 cfm, with machine-direction and cross-direction shrinkage of less than about 3%, and more preferably, less than about 2%. The filter media preferably exhibits a machine-direction tensile strength of at least about 50 lb/in, and a cross-direction tensile strength of at least about 50 lb/in, in accordance with ASTM D461-93, Section 12.

The accompanying Table sets forth performance characteristics for filter media formed in accordance with the present invention in comparison to a conventional needle-punched nonwoven fabric having a basis weight of 16 oz/yd², designated Menardi 50-575. As the test results indicate, a filter media formed in accordance with the present invention exhibits performance comparable to that achieved with the needle-punched fabric, notwithstanding the significant difference in basis weights of the two fabrics.

From the foregoing, numerous modifications and variations can be effected without departing from the true spirit and scope of the novel concept of the present invention. It is to be understood that no limitation with respect to the specific embodiments disclosed herein is intended or should be inferred. The disclosure is intended to cover, by the appended claims, all such modifications as fall within the scope of the claims.

1. A method of making a liquid filter media comprising the steps of:
providing a precursor web comprising predominant staple length polyester fibers; and
providing a foraminous surface, positioning said precursor web and said foraminous surface, and hydroentangling said precursor web to form said filter media, said filter media having a basis weight of no more than about 12 oz/yd², and exhibiting an air permeability of at least about 180 cfm, and machine-direction and cross-direction shrinkage of less than about 3%, said liquid filter media further exhibiting greater than about 85% capture efficiency with particles sizes in the range of 30 to 40 microns and exhibiting greater than about 60% capture efficiency with particle sizes in the range of 20 to 30 microns.

2. A method of making a filter media in accordance with claim 1, including:
heat-setting said filter media after said hydroentangling step.

3. A method of making a filter media in accordance with claim 2, wherein said precursor web comprises fusible fibers whereby said filter media is thermally bonded during said heat-setting step.

4. A filter media comprising hydroentangled, predominant polyester staple length fibers having a basis weight of no more than about 12 oz/yd², an air permeability of at least about 180 cfm, and machine-direction and cross-direction shrinkage of less than about 3%, said liquid filter media further exhibiting greater than about 85% capture efficiency with particle sizes in the range of 30 to 40 microns and exhibiting greater than about 60% capture efficiency with particle sizes in the range of 20 to 30 microns.

5. A filter media in accordance with claim 4, wherein said media exhibits machine-direction and cross-direction shrinkage of less than about 2%.

6. A filter media in accordance with claim 4, wherein said filter media exhibits a machine-direction tensile strength of at least about 50 lb/in and a cross-direction tensile strength of at least about 50 lb/in.

7. A filter media in accordance with claim 1, wherein said filter media is a gas filter.

8. A filter media in accordance with claim 1, wherein said filter media is an air filter.

9. A filter media in accordance with claim 1, wherein said filter media is a liquid filter.
